(19) United States
(12) Patent Application Publication
(10) Pub. No.: US 2022/0259796 A1
(43) Pub. Date: Aug. 18, 2022

(54) LAUNDRY DEVICE WITH A DRIVE SYSTEM

(71) Applicant: BSH Hausgeraete GmbH, Muenchen (DE)

(72) Inventors: Rainer Berger, Buehl (DE); Matti Dachman, Udim (IL); Torsten Eckardt, Grosstreben-Zwethau (DE); Isaac Naor, Hod-Hasharon (IL); Andreas Obermeier, Pielenhofen (DE); Sebastian Schwinzer, Hennigsdorf (DE)

(21) Appl. No.: 17/625,849

(22) PCT Filed: Jul. 7, 2020
(86) PCT No.: PCT/EP2020/069070

§ 371 Date: Jan. 10, 2022

(30) Foreign Application Priority Data
Jul. 9, 2019 (DE) 10 2019 210 124.0

(51) Int. Cl. D06F 89/00; G05B 19/042

(52) U.S. Cl. CPC D06F 89/00; G05B 2219/2633; G05B 19/0426

(57) ABSTRACT

A laundry device has a drive system. The drive system contains a plurality of actuators for executing synchronized adjusting actions, a plurality of decentralized control modules assigned to the respective actuators and are connected to one another via a data bus, and a central controller for controlling the actuators via the data bus and the decentralized control modules. The central controller is configured to send a preconditioning message with information relating to preconditioning an adjusting action of at least one portion of the actuators via the data bus to the decentralized control modules. The central controller or one of the decentralized control modules is configured to send a trigger signal to the decentralized control modules via a trigger line after the sending of the preconditioning message. The trigger signal prompts the decentralized control modules to control the actuators in a temporally synchronized manner according to the preconditioned adjusting action.

The present invention relates to a laundry device with a drive system having a plurality of actuators, a plurality of decentralized control modules, and a central controller.

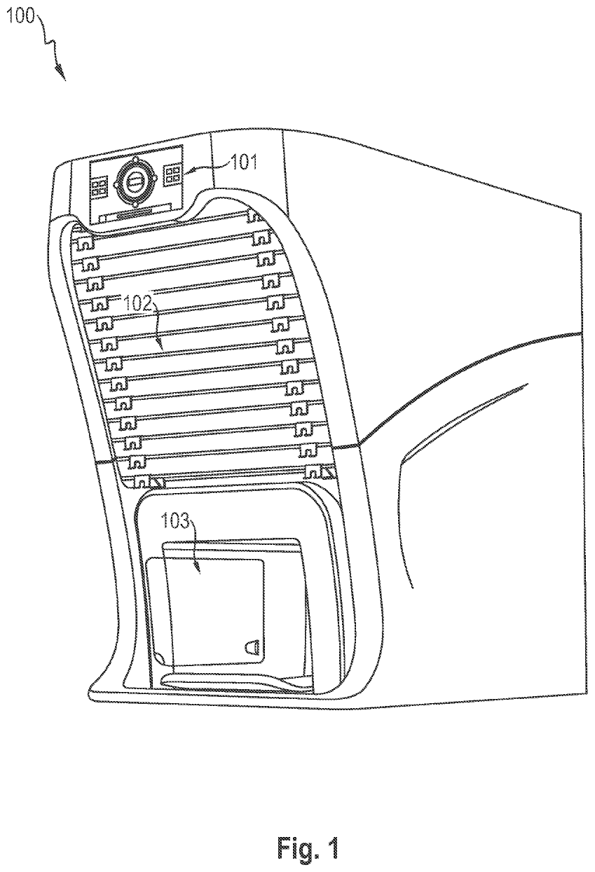

FIG. 1 shows a laundry folding device 100 (also called a “Foldimate”) with a plurality of slots 102 for laying or hanging laundry items inside, and an outlet compartment 103 for outputting the folded laundry items. The laundry folding operation is started via a control panel 101. In an exemplary embodiment of the laundry folding device 100 14 drives (not shown in FIG. 1 since located inside the casing) are employed for different drive tasks. The drives are intended to transport a textile (laundry item) through the machine 100 and fold it during the said transporting. The drives act on the folding mechanism, consisting of conveyor belts and folding rollers, and also linearly adjustable infeeds, guideways, gap settings, and a stacking facility (not shown in FIG. 1 since located inside the casing). A central controller (master) is intended to specify the folding process; the decentralized motor controllers (MCU, “motor control unit”) integrated in the drive are intended to convert commands of the master into function-independent adjustments. The mechanism of the laundry folder 100 is divided over several levels; hand-over of the laundry items between the levels must take place in a synchronous manner so that the textiles are folded without a backlog building up. Precise simultaneous start and stop operations, and also positionings, are required to achieve a good folding result. The temporal requirements lie in the millisecond range due to the speed of throughput, and with a positioning synchronicity of an armature revolution.

Drive systems with multiple actuators are frequently implemented with the aid of central electronics that control multiple actuators. The control logic is computed in a processor core; as a result the functional interfaces between the individual actuators can be mapped in software and synchronous control can be effected in the millisecond range. Such drive systems are used in a laundry device, e.g. in the laundry device 100 in FIG. 1. But such drive systems can also be employed in other devices, for example in a seat adjustment system in an automobile, or also in a printer with multiple rollers for transporting the paper.

In decentralized systems a horizontal architecture with fast bus connections is employed to achieve the response times of real-time requirements. To do this baud rates in the range from around 500 kbps to around 1000 kbps are needed. Therefore 30 to 60 bytes of useful data can be transmitted per ms to make synchronous activation possible. However bus systems with such baud rates are costly due to the cabling (screening, multiple lines) and need hardware controllers (e.g. CAN, RS-485).

Given sufficient robustness and EMV simpler bus systems with a single-wire master/slave connection using a polling method achieve a baud rate of 115 kbps at most. Simultaneous starting/stopping of the drives in the millisecond range is therefore impossible since a maximum of 20 bytes of useful data can be transmitted per millisecond (for example LIN, K-Line).

The object underlying the invention is to design a laundry device, in particular a laundry folder, and a drive system for such a laundry device, which can perform its drive tasks with a simple bus system with a low baud rate.

In particular the object of the invention is to create a concept for the synchronous execution of actions in a system with multiple participants while using a simple bus system with a low baud rate (from around 9.6 to 115 kbps).

This task is achieved by the subject matter together with the features according to the independent claims. Advantageous embodiments form the subject matter of the dependent claims, the description, and the drawings.

A fundamental idea of the invention consists in using a two-stage method for synchronous starting of tasks in a distributed (decentralized) drive system with slow bus transmission, which comprises the following two steps. Step 1: asynchronous task conditioning of the nodes with the aid of (slow) messages. Step 2: synchronous initiation of the tasks with the aid of a coded trigger signal. Messages are controlled by the bus master (in a polling method). Each node can generate trigger signals in an event-controlled manner. Slow bus transmission is to be understood here to mean transmission with a low baud rate (from around 9.6 to 115 kbps).

According to a first aspect the inventive object is achieved by a laundry device with a drive system comprising: a plurality of actuators for executing synchronized adjusting actions; a plurality of decentralized control modules, which are assigned to the respective actuators, and which are connected to one another via a data bus; a central controller for controlling the actuators via the data bus and the decentralized control modules, wherein the central controller is designed to send a preconditioning message with information relating to preconditioning an adjusting action of at least one portion of the actuators via the data bus to the decentralized control modules, wherein the central controller or one of the decentralized control modules are designed to send a trigger signal to the decentralized control modules via a trigger line after the sending of the preconditioning message, wherein the trigger signal prompts the decentralized control modules to activate the actuators in a temporally synchronous manner according to the preconditioned adjusting action.

This achieves the technical advantage that the laundry device can perform its drive tasks with a simple bus system with a low baud rate. The respective motor actions are executed in a synchronous manner in a system with multiple participants or actuators, where a simple bus system with a low baud rate (from around 9.6 to 115 kbps) can be deployed. To do this the drive system of the laundry device uses a two-stage method for synchronous starting of tasks, which is suited in particular to drive systems with slow bus transmission. In this regard the method comprises the two steps: asynchronous task conditioning of the nodes with the aid of (slow) messages, and synchronous initiation of the tasks with the aid of a coded trigger signal.

Messages are controlled by the bus master (in a polling method). Each node can generate trigger signals in an event-controlled manner. Slow bus transmission is to be understood here to mean transmission with a low baud rate (from around 9.6 to 115 kbps) or high latency time of up to around 10 milliseconds.

In an advantageous embodiment of the laundry device the central controller is designed to transmit the preconditioning message asynchronously to the decentralized control modules via the data bus.

This achieves the technical advantage that no restrictive specifications have to be observed so that the bus system does not need to be implemented in a particularly fast form. There is sufficient time to transmit the preconditioning message to the decentralized control modules via the data bus.

In an advantageous embodiment of the laundry device the central controller is designed to transmit the preconditioning message to the decentralized control modules via the data bus according to a serial single-wire bus protocol with master/slave configuration.

This achieves the technical advantage that the preconditioning message can be transmitted via the existing infrastructure. There is no need to set up a new fast transmission line.

In an advantageous embodiment of the laundry device the central controller comprises a bus master, which is designed to activate the decentralized control modules in a polling method.

This achieves the technical advantage that, by way of this bus master controller, each decentralized control module is accessible in a simple manner via the existing bus. Separate lines for each control module are not necessary.

In an advantageous embodiment of the laundry device the central controller is designed to activate the decentralized control modules with a latency time of more than 20 milliseconds.

This achieves the technical advantage that the drive system can work efficiently with slow buses where the latency is 20 milliseconds but nevertheless the requirements for synchronicity of motor activation can still be met.

In an advantageous embodiment of the laundry device the preconditioning message extends over one or more data frames, wherein each data frame comprises an identifier of a corresponding actuator of that portion of the actuators that are affected by the preconditioning.

This achieves the technical advantage that existing data protocols, such as e.g. LIN, CAN, RS-485, field bus, etc., can continue to be used. The “Local Interconnect Network” (LIN), also referred to as LIN bus, is a serial communications system for networking sensors and actuators, a field bus. The CAN bus (Controller Area Network) is a serial bus system and is one of the field buses. RS-485 is an industry standard for a physical interface for asynchronous serial data transmission.

In an advantageous embodiment of the laundry device the central controller is designed to interrupt data traffic on the data bus and to send the trigger signal via the data bus during the interruption.

This achieves the technical advantage that no external trigger line is necessary since the trigger signal can be transmitted via the existing data bus, which simplifies the design.

In an advantageous embodiment of the laundry device the central controller is designed to activate the actuators in a temporally synchronous manner within a data frame on the data bus that follows the trigger signal.

This achieves the technical advantage that high temporal synchronization requirements for activating the motors can be met.

In an advantageous embodiment of the laundry device the adjusting action occurs in response to a sensor signal, which indicates a status transition of an actuator that does not belong to the portion of the actuators to be adjusted.

This achieves the technical advantage that when a certain status is captured via the sensor a plurality of motor actions can be executed in a coordinated manner.

In an advantageous embodiment of the laundry device the trigger signal comprises a coding, which states a specific configuration of the adjusting action.

This achieves the technical advantage that the adjusting action does not have to be specified via an additional message and the drive system can be implemented in a simple manner.

In an advantageous embodiment of the laundry device the trigger signal is coded on the basis of a pulse length of the trigger signal.

This achieves the technical advantage that the pulse length represents a simple option for coding, by means of which additional information can be transmitted efficiently.

In an advantageous embodiment of the laundry device the drive system comprises a trigger circuit, which is designed to generate and/or to read the trigger signal, wherein the central controller and/or the decentralized control modules are designed to activate the trigger circuit to generate and/or to read the trigger signal.

This achieves the technical advantage that the trigger signal can be both generated and also read.

In an advantageous embodiment of the laundry device the trigger circuit comprises the following: a trigger line for providing the trigger signal; a transistor, which activates the trigger line to adopt a first or a second potential; a first port, which activates the transistor to set the trigger line to the second potential; and a second port, which indicates a status of the trigger line.

This achieves the technical advantage that the trigger circuit can be constructed in a simple manner and essentially consist of a transistor that switches a first potential or a second potential onto the trigger line. The trigger circuit can be implemented in the form of an external circuit or as part of the central controller.

According to a second aspect the inventive object is achieved by a drive system for a laundry device, wherein the drive system comprises the following: a plurality of actuators for executing synchronized adjusting actions; a plurality of decentralized control modules, which are assigned to the respective actuators, and which are connected to one another via a data bus; a central controller for controlling the actuators via the data bus and the decentralized control modules, wherein the central controller is designed to send a preconditioning message with information relating to preconditioning an adjusting action of at least one portion of the actuators via the data bus to the decentralized control modules, wherein the central controller or one of the decentralized control modules are designed to send a trigger signal to the decentralized control modules via a trigger line after the sending of the preconditioning message, wherein the trigger signal prompts the decentralized control modules to activate the actuators in a temporally synchronous manner according to the preconditioned adjusting action.

This achieves the technical advantage that the laundry device can perform its drive tasks with a simple bus system with a low baud rate. The respective motor actions are executed in a synchronous manner in a system with multiple participants or actuators, where a simple bus system with a low baud rate (e.g. from around 9.6 to 115 kbps) can be deployed. To do this the drive system of the laundry device uses a two-stage method for synchronous starting of tasks, which is suited in particular to drive systems with slow bus transmission. In this regard the method comprises the two steps: asynchronous task conditioning of the nodes with the aid of (slow) messages, and synchronous initiation of the tasks with the aid of a coded trigger signal. Messages are controlled by the bus master (in a polling method).

According to a third aspect the inventive object is achieved by a method for operating a laundry device with a drive system, wherein the drive system comprises the following: a plurality of actuators for executing synchronized adjusting actions; a plurality of decentralized control modules, which are assigned to the respective actuators, and which are connected to one another via a data bus; and a central controller for controlling the actuators via the data bus and the decentralized control modules, wherein the method comprises the following steps: sending a preconditioning message with information relating to preconditioning an adjusting action of at least one portion of the actuators by the central controller via the data bus to the decentralized control modules; and sending a trigger signal from the central controller or from one of the decentralized control modules to the decentralized control modules via a trigger line after the sending of the preconditioning message, wherein the trigger signal prompts the decentralized control modules to activate the actuators in a temporally synchronous manner according to the preconditioned adjusting action.

This achieves the technical advantage that the method can be deployed in a drive system with a simple bus system with a low baud rate. The respective motor actions are executed in a synchronous manner in a system with multiple participants or actuators, where a simple bus system with a low baud rate (e.g. from around 9.6 to 115 kbps) can be deployed. In this regard the method has two stages and comprises the two steps: asynchronous task conditioning of the nodes with the aid of (slow) messages, and synchronous initiation of the tasks with the aid of a coded trigger signal.

Exemplary embodiments of the invention are illustrated in the drawings and are described in detail below.

The drawings show:

FIG. 1 A 3-dimensional illustration of a laundry device 100 in the embodiment as a laundry folding machine, by way of example;

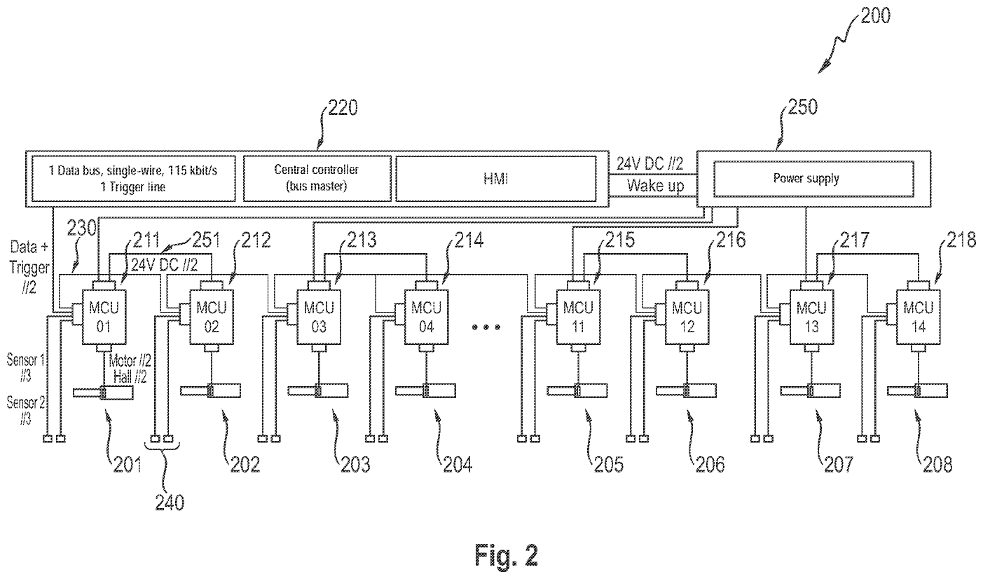

FIG. 2 A system architecture of a drive system 200 for a laundry device according to an exemplary embodiment;

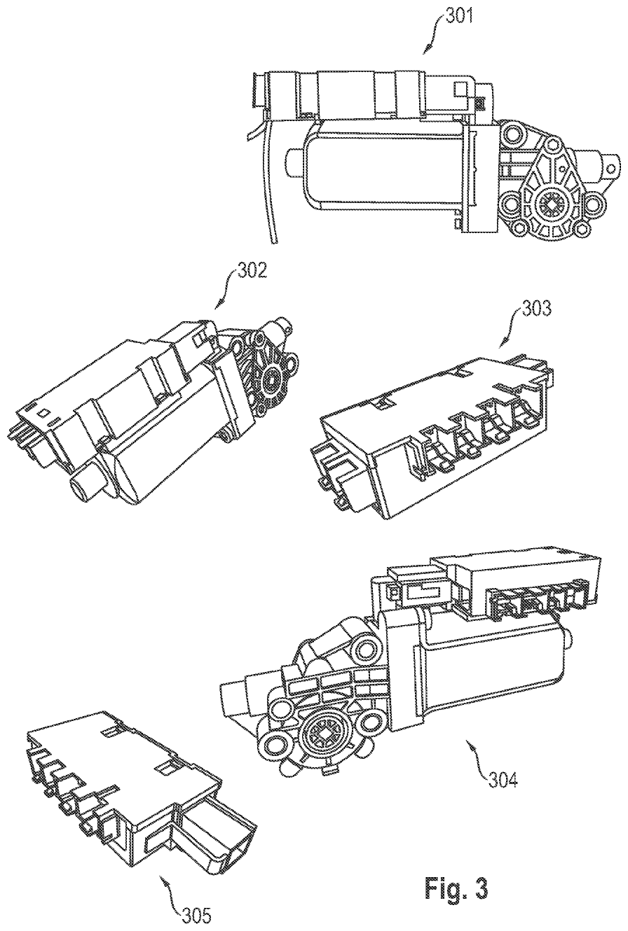

FIG. 3 Various 3-dimensional illustrations of an arrangement consisting of a motor control unit and motor of a drive system 200 for a laundry device 100 according to an exemplary embodiment;

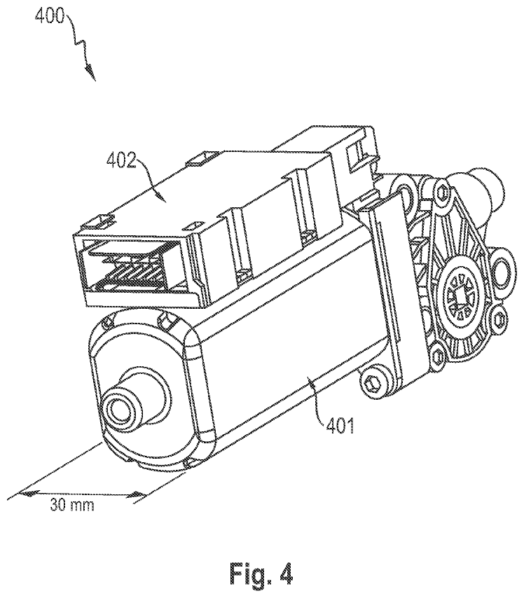

FIG. 4 A 3-dimensional illustration of an arrangement 400 consisting of a motor control unit and motor of a drive system 200 for a laundry device according to an exemplary embodiment;

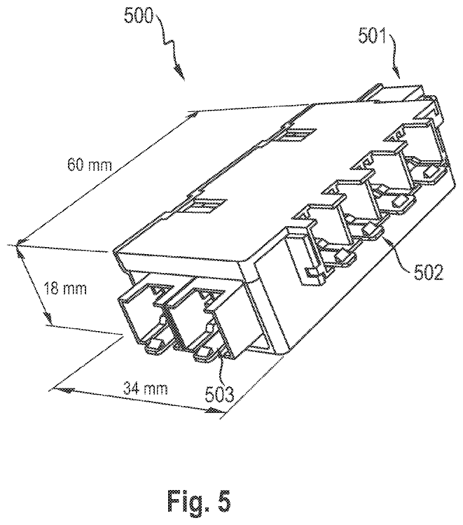

FIG. 5 A 3-dimensional illustration of a motor control unit 500 of a drive system 200 for a laundry device according to an exemplary embodiment;

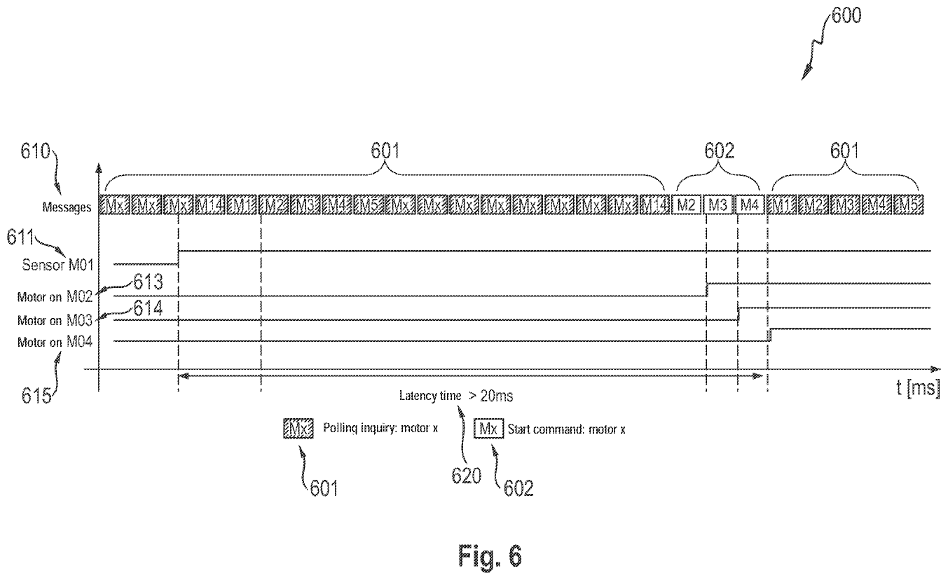

FIG. 6 A signal diagram 600 of the activation signals of a drive system 200 for a laundry device according to an embodiment without a trigger signal;

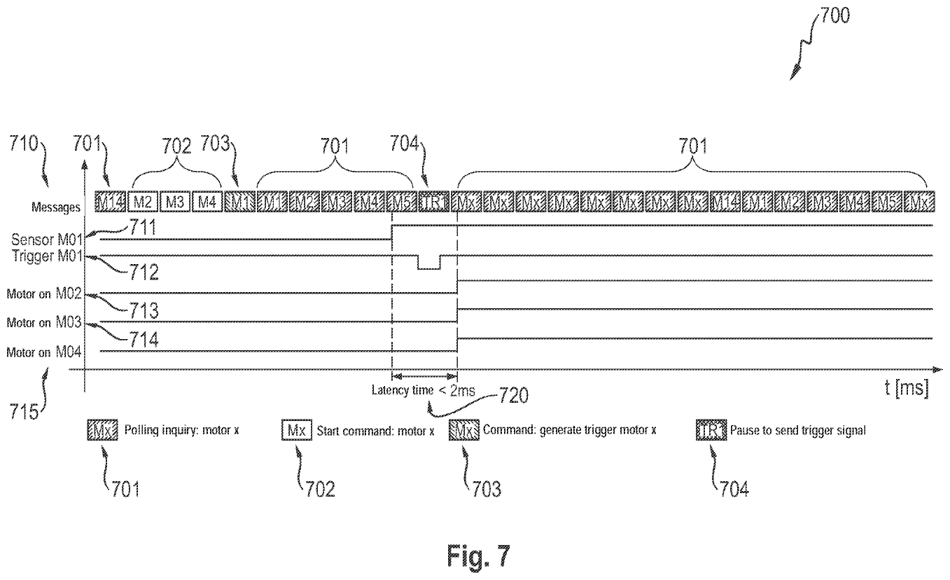

FIG. 7 A signal diagram 700 of the activation signals of a drive system 200 for a laundry device according to an embodiment incorporating use of an inventive trigger signal;

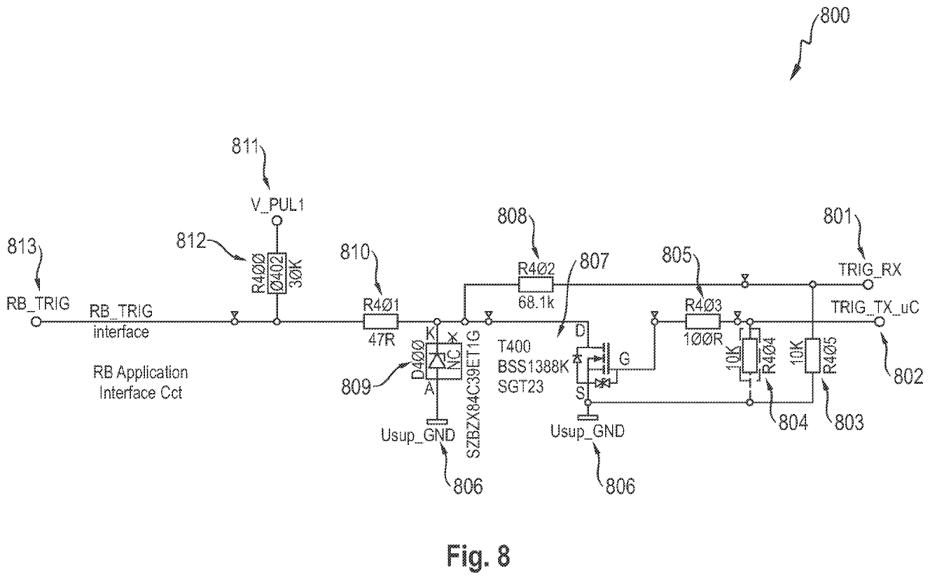

FIG. 8 A circuit for generating a trigger signal for a drive system 200 for a laundry device according to an exemplary embodiment;

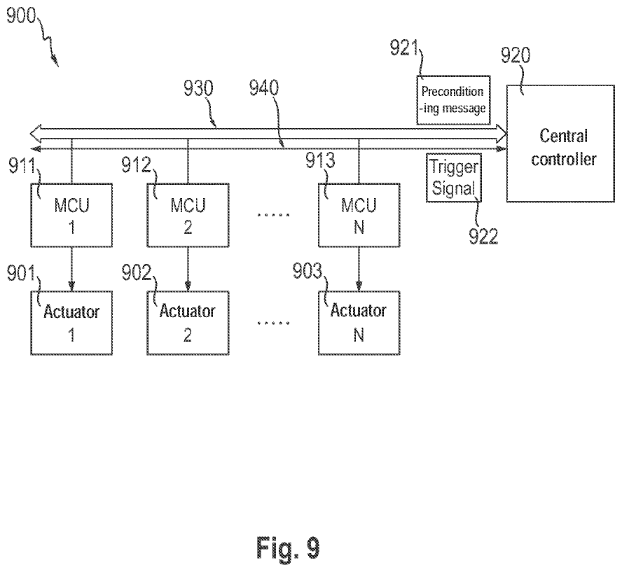

FIG. 9 A system architecture of a drive system 900 for a laundry device according to an exemplary embodiment; and

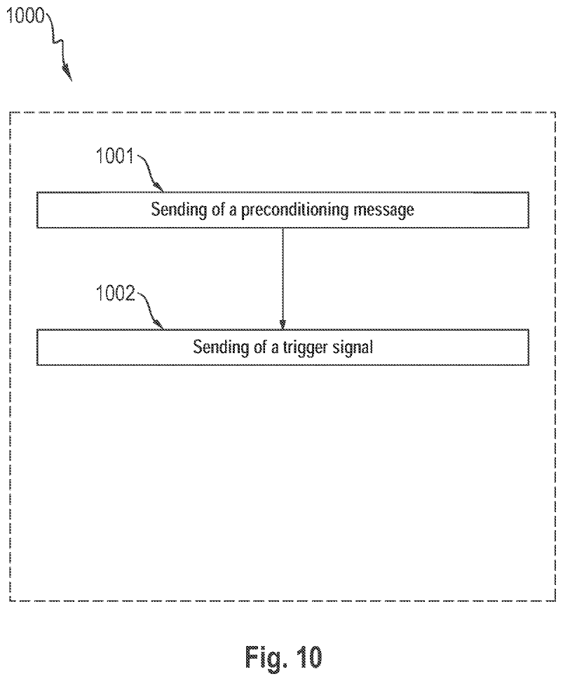

FIG. 10 A schematic illustration of a method 1000 for operating a laundry device 100 with a drive system according to an exemplary embodiment.

FIG. 2 shows a system architecture of a drive system 200 for a laundry device according to an exemplary embodiment.

The drive system 200 consists of a central controller 220, also referred to as a bus master, and an exemplary number of 14 actuators or motors respectively 201, 202, 203, 204, 205, 206, 207, 208 with electronic motor control (MCU) in the form of slave bus nodes, also referred to as decentralized control modules 211, 212, 213, 214, 215, 215, 217, 218. All these nodes 211, 212, 213, 214, 215, 216, 217, 218 are connected by a line 230 for the data bus and a line 230 for the trigger signals. The said line, which is represented by the reference character 230, runs from the central controller 220 to the first MCU 211, continues via the second MCU 212, the third MCU 213, the fourth MCU 214, the further fifth to tenth MCUs not illustrated in FIG. 2, the eleventh MCU 215, the twelfth MCU 216, the thirteenth MCU 217 up to the fourteenth MCU 218. Alternatively the trigger signals can also be transmitted on the data line 230, i.e. without a dedicated trigger line. The actuators or motors respectively 201, 202, 203, 204, 205, 206, 207, 208 are implemented in the form of DC motors with brush-gear in an embodiment.

Furthermore all the nodes 211, 212, 213, 214, 215, 216, 217, 218 are equipped with a respective line 240, which is connected to a corresponding sensor of the respective node, in order to read in or receive the corresponding sensor signals. Furthermore all the nodes 211, 212, 213, 214, 215, 216, 217, 218 have a power supply line 251, which supplies the corresponding node with the necessary voltage or power, which is delivered by the power supply 250.

In the operating mode of the drive system 200 the bus master 220 sends data frames or frames, which consist for example of the data fields “Break”, “Sync”, “Frame ID”, and have e.g. 8 bytes of useful data and also a data check field (checksum). For example these data frames can be constructed in accordance with the LIN (Local Interconnect Network) standard, i.e. a standard from automobile engineering. The “Local Interconnect Network” (LIN), also referred to as LIN-Bus, is a serial communication system for networking sensors and actuators, a field bus. LIN is used where the bandwidth and versatility of CAN is not needed. Typical application examples comprise the networking inside the door or the seat of a motor vehicle.

In an embodiment the frame is always sent by the bus master 220 (in a scheduling method); the useful data and the checksum can be sent by the bus master 220 or by a slave node (i.e. one of the MCUs 211, 212, 213, 214, 215, 216, 217, 218) depending on the send direction. At a baud rate of 115 kbps the transmission of one frame takes 1 millisecond. To start up e.g. three actuators simultaneously from the bus master 220, there is therefore a latency time of at least 3 milliseconds. If it is desired to respond to sensor signals from the actuators and interrogate the corresponding status of the respective motors 201, 202, 203, 204, 205, 206, 207, 208, further messages are added, which results in a further lengthening of the latency time as shown in detail in the illustration in FIG. 6.

This is where the invention comes in. Due to the two-stage method described in detail in this application tasks can be started synchronously in a distributed (decentralized) drive system with slow bus transmission, i.e. the drive system 200. The method comprises the following two steps. Step 1: asynchronous task conditioning of the nodes with the aid of (slow) messages. Step 2: synchronous initiation of the tasks with the aid of a coded trigger signal. The drive system 200 can therefore function reliably even in operation with a low baud rate, as described in detail in the illustration in FIG. 7.

The following FIGS. 3 to 5 show various exemplary illustrations of motors with motor control units (MCUs) such as can be employed in the drive system 200 in FIG. 2.

FIG. 3 shows various 3-dimensional illustrations of an arrangement consisting of a motor control unit and motor of a drive system 200 for a laundry device according to an exemplary embodiment. In the illustration 301 the motor controller (MCU) is attached to the housing of the motor. The cables shown at the end of the motor controller (MCU) are used for the voltage supply to the motor controller. A different perspective of motor and motor controller can be seen in the illustration 302. In the illustration 303 the motor controller is shown on its own. The illustration 304 shows a further perspective of motor and motor controller. The motor controller can be seen on its own in a different perspective in the illustration 305.

FIG. 4 shows a 3-dimensional illustration of an arrangement 400 consisting of a motor control unit 402 and motor 401 of a drive system 200 for a laundry device according to an exemplary embodiment. The motor controller (MCU) 402 is attached to a pole housing of the motor 401. The motor 401 is constructed very compactly; its diameter at the axle comprises around 3 cm so it is well suited to being employed in the laundry folding machine 100 according to FIG. 1.

FIG. 5 shows a 3-dimensional illustration of a motor control unit 500 of a drive system 200 for a laundry device according to an exemplary embodiment The motor control unit 500 can be attached to a motor. The motor control unit 500 comprises a motor connection 501, e.g. in a Delphi 4-pin implementation, a signal connection 502, e.g. in a RAST 2.5 implementation with 2×2 pins for the bus and 2×3 pins for the optical sensors. Furthermore the motor control unit 500 comprises a power connection 503, e.g. in a RAST-2.5-plus™ implementation with 2×2 pins. The motor control unit 500 can have a controller printed circuit board (not shown) inside the housing to execute the corresponding control tasks. The connections 501, 502, 503 illustrated can be connected to the controller printed circuit board. The motor control unit 500 can be implemented in very compact manner, e.g. with a length of 6 cm, a width of 3.4 cm, and a height of 1.8 cm so that it can very easily be placed on to a motor 401 as shown in FIG. 4.

FIG. 6 shows a signal diagram 600 of the activation signals of a drive system 200 for a laundry device according to an embodiment without a trigger signal.

As an application example the motor controllers MCU02, MCU03, MCU04 should cause their respective motors to start up simultaneously when the sensor 1 at the motor controller MCU01 changes its status from 0 to 1. The sensor signal 611 at the motor controller MCU01 and also the motor control signals 613, 614, 615 of the motor controllers MCU02, MCU03, and MCU04 or of the corresponding motors M02, M03, M04, and the data signal or messages 610 are illustrated in FIG. 6.

The messages 610 are sent in the form of frames or data frames as described above in relation to FIG. 2. In this regard the corresponding motor controller x is interrogated or notified in the polling operation with each data frame Mx. After a corresponding message sequence in which all 14 motor controllers have been interrogated the start commands 602 for the motor controllers 2, 3, and 4 are transmitted, which switch on the corresponding motors M02, M03, and M04. The respective switch-on signals 613, 614, 615 for the motors M02, M03, M04 are illustrated in the figure. Due to activation in the polling method a delay or latency time 620 of more than 20 milliseconds can arise until the motors can be switched on. Such a large latency time 620 can be damaging for the control process so that the synchronicity of the individual motors with respect to each other is not guaranteed.

FIG. 7 shows a signal diagram 700 of the activation signals of a drive system 200 for a laundry device according to an embodiment incorporating use of an inventive trigger signal.

The application scenario is the same as that described above in relation to FIG. 6, i.e. the motor controllers MCU02, MCU03, MCU04 should cause their respective motors to start up simultaneously when the sensor 1 at the motor controller MCU01 changes its status from 0 to 1. The sensor signal 711 at the motor controller MCU01, the trigger signal 712, and also the motor control signals 713, 714, 715 of the motor controllers MCU02, MCU03, and MCU04 or of the corresponding motors M02, M03, M04, and the data signal or the messages 710 are illustrated in FIG. 7.

The messages 710 are sent in the form of frames or data frames as described above in relation to FIG. 2 and also in relation to FIG. 6. In this regard the corresponding motor controller x is interrogated or notified in the polling operation with each data frame Mx 701. In a corresponding message sequence in which all 14 motor controllers have been interrogated via corresponding data frames Mx 701 a preconditioning message 702, consisting of the start commands M2, M3, and M4, is transmitted at a time point predetermined by the central controller to the corresponding motor controllers 2, 3, and 4, which are to switch on the corresponding motors M02, M03, and M04. The preconditioning message 702 does not bring about switch-on of the corresponding motors M02, M03, and M04 yet however, but just a preparing of the corresponding motor controllers MCU02, MCU03, and MCU04 to stand ready to send the activation signal to switch on the motors M02, M03, and M04 as soon as the trigger signal is received. After this a trigger command M1, 701, is sent to the motor control unit MCU01, which is to generate the trigger signal upon a change in status of the sensor signal applied to it.

If the motor control unit MCU01 then receives the change in status, from 0 to 1, of the sensor signal 711 applied to it, as illustrated in FIG. 7, then the motor control unit MCU01 is prepared, on the basis of the frame M1 703 received previously, to send the trigger signal 704. In the illustration in FIG. 7 the trigger signal 704 corresponds to a pause in the profile of the signal 711, i.e. a transition from 1 to 0 and back to 1 after the passage of the frame length of the trigger signal 704. The trigger signal can be sent on an external data line or alternatively on a line of the data bus. The trigger signal 704 is received by all motor control units and triggers or initiates the previously prepared motor control units MCU02, MCU03, and MCU04 to switch on the motors assigned to them. Due to the preconditioning by the preconditioning message 702 previously sent the switching on of the motors M02, M03, and M04 occurs synchronously and with a latency time of less than 2 milliseconds, which corresponds roughly to the length of two data frames.

In alternative embodiments the latency time can be down to around less than 10 milliseconds to achieve adequate precision in activating the individual motors of the drive system 200 synchronously.

FIG. 8 shows a trigger circuit 800 for generating a trigger signal for a drive system 200 for a laundry device according to an exemplary embodiment.

The trigger circuit 800 comprises a trigger line 813 for providing the trigger signal, i.e. a trigger signal 704 as described in FIG. 7. The trigger circuit 800 furthermore comprises a transistor 807, which activates the trigger line 813 to assume a first potential 811 or a second potential 806. The trigger circuit 800 comprises a first port 802, which activates the transistor 807 to set the trigger line 813 to the second potential 806; and a second port 801, which indicates a status of the trigger line 813.

The circuit 800 is designed such that the first potential 811 (V_PU_1) is the dominating level that is reset to the second potential (Usup_GND) 806, i.e. ground, when the transistor 807 is switched. The control line or gate G of the transistor 806 is activated via a signal at the first port 802 to switch the transistor 806 to conducting so that the second potential (Usup_GND) 806 is switched on to the trigger line 813 or to blocking so that the first potential 811 (V_PU_1) is switched on to the trigger line 813. Various resistances 803, 804, 805, 808, 810, 812 and a diode 809 ensure stable operation of the circuit 800.

Embodiments of the drive system 200 that are equipped with the trigger circuit 800 are described below.

The circuit 800 is available for all participants or motor control units MCUs 211 to 218. The point or output port RB_TRIG 813 is electrically connected to all participants. By means of microcontrollers each participant can pull the line to ground via the transistor T400 (reference character 807) and the point or first port TRIG_TX_μC (reference character 802), and read back the status of the line via the point or second port TRIG_RX (reference character 801).

There are two main alternatives for the implementation of the drive system; A) the trigger signal is routed via a separate line. In this regard the bus traffic and the trigger signal can take place in parallel and independently of each other. B) the trigger signal is sent on the data line. In this regard the bus traffic has to be paused to send the trigger signal. The point or output port RB_TRIG is electrically connected to the data bus line in this regard, see block TR1 (reference character 704) in FIG. 7.

The trigger signal can have a coding as described below.

The trigger signal can be varied, e.g. in 0.5 millisecond steps. As a result different actions can be active in parallel and be started up via the trigger pulse length. Each participant can generate the trigger pulse length and also measure the trigger pulse length upon receipt.

For example a first trigger code can be coded as pulse length 0.5 milliseconds. This trigger code can be generated by MCU1 upon a change of signal at the sensor 2. The first trigger code has the effect that the motors 5 and 8 stop or pause upon receipt of the first trigger code.

For example a fifth trigger code can be coded as pulse length 2.5 milliseconds. This trigger code can be generated by MCU8 upon a change of signal at the sensor 1. The fifth trigger code has the effect that the motors 9 and 10 start up upon receipt of the fifth trigger code.

The data commands should preferably be limited to basic motor functions to enable a use that is independent of the application. Coordination of the overall process is the task of the master or the central controller with bus master 220 in FIG. 2. For example the following data commands can be generated:
generate trigger X upon change of sensor
generate trigger X upon reaching position Y
start motor upon receiving trigger X
stop motor upon receiving trigger X
move to position Y upon receiving trigger X
set the position counter upon receiving trigger X

FIG. 9 shows a system architecture of a drive system 900 for a laundry device according to an exemplary embodiment. The system architecture is a simplified illustration of the system architecture illustrated in FIG. 2, which illustrates the fundamental components of the drive system 900.

The drive system 900 comprises a plurality of actuators 901, 902, 903 for executing synchronized adjusting actions; a plurality of decentralized control modules 911, 912, 913, which are assigned to the respective actuators 901, 902, 903, and which are connected to one another via a data bus 930; and a central controller 920 for controlling the actuators 901, 902, 903 via the data bus 930 and the decentralized control modules 911, 912, 913. The central controller 920 is designed to send a preconditioning message 921 with information relating to preconditioning an adjusting action of at least one portion of the actuators 901, 902, 903 via the data bus 930 to the decentralized control modules 911, 912, 913. In this regard the central controller 920 or one of the decentralized control modules 911, 912, 913 are designed to send a trigger signal 922 to the decentralized control modules 911, 912, 913 via a trigger line 940 after the sending of the preconditioning message 921. The trigger signal 922 prompts the decentralized control modules 911, 912, 913 to activate the actuators 901, 902, 903 in a temporally synchronous manner according to the preconditioned adjusting action.

The actuators 901, 902, 903 correspond to the motors M01, M02 to M14 in FIG. 2. The decentralized control modules 911, 912, 913 correspond to the motor control units MCU01 to MCU14 in FIG. 2. The data bus 930 and the trigger line 940 correspond to the data bus with trigger line 230 according to FIG. 2. The central controller 920 corresponds to the central controller 220 with bus master in FIG. 2. The preconditioning message 921 corresponds to the message 702 according to FIG. 7. The trigger signal 922 corresponds to the trigger signal 704 in FIG. 7.

In an embodiment the central controller 920 is designed to transmit the preconditioning message 921 asynchronously to the decentralized control modules 911, 912, 913 via the data bus 930. In an embodiment the central controller 920 is designed to transmit the preconditioning message 921 to the decentralized control modules 911, 912, 913 via the data bus 930 according to a serial single-wire bus protocol with master/slave configuration. In an embodiment the central controller 920 comprises a bus master, which is designed to activate the decentralized control modules 911, 912, 913 in a polling method. In an embodiment the central controller 920 is designed to activate the decentralized control modules 911, 912, 913 with a latency time of more than 20 milliseconds.

In an embodiment the preconditioning message 921 extends over one or more data frames, as illustrated in FIG. 7, wherein each data frame comprises an identifier of a corresponding actuator of that portion of the actuators 901, 902, 903 that are affected by the preconditioning.

In an embodiment the central controller 920 is designed to interrupt data traffic on the data bus 930 and to send the trigger signal 922 via the data bus 930 during the interruption. In an embodiment the central controller 920 is designed to activate the actuators 901, 902, 903 in a temporally synchronous manner within a data frame on the data bus 930 that follows the trigger signal 922. In an embodiment the adjusting action occurs in response to a sensor signal, which indicates a status transition of an actuator that does not belong to the portion of the actuators 901, 902, 903 to be adjusted. Alternatively this actuator can also be one of the actuators 901, 902, 903 to be adjusted however.

In an embodiment the trigger signal 922 comprises a coding, which states a specific configuration of the adjusting action. In an embodiment the trigger signal 922 is coded on the basis of a pulse length of the trigger signal 922.

In an embodiment the drive system 900 comprises a trigger circuit 800, which is designed to generate and/or to read the trigger signal 922. In an embodiment the central controller 920 and/or the decentralized control modules 911, 912, 913 are designed to activate the trigger circuit 800 to generate and/or to read the trigger signal 922. In an embodiment the trigger circuit 800 comprises the following: a trigger line 813 for providing the trigger signal 922; a transistor 807, which activates the trigger line 813 to adopt a first 811 or a second 806 potential; a first port 802, which activates the transistor 807 to set the trigger line 813 to the second potential 806; and a second port 801, which indicates a status of the trigger line 813.

FIG. 10 shows a schematic illustration of a method 1000 for operating a laundry device 100 with a drive system according to an exemplary embodiment. In this regard the drive system 900 comprises a plurality of actuators 901, 902, 903 for executing synchronized adjusting actions; a plurality of decentralized control modules 911, 912, 913, which are assigned to the respective actuators, and which are connected to one another via a data bus 930; and a central controller 920 for controlling the actuators 901, 902, 903 via the data bus 930 and the decentralized control modules 911, 912, 913, as described in detail in relation to FIGS. 9 and 2.

The method 1000 comprises the following steps: sending 1001 a preconditioning message 921 with information relating to preconditioning an adjusting action of at least one portion of the actuators 901, 902, 903 by the central controller 920 via the data bus 930 to the decentralized control modules 911, 912, 913, as described in detail above in relation to FIGS. 9, 2, and 7; and sending 1002 a trigger signal 922 from the central controller 920 or from one of the decentralized control modules to the decentralized control modules 911, 912, 913 via a trigger line 940 after the sending of the preconditioning message 921, wherein the trigger signal 922 prompts the decentralized control modules to activate the actuators 901, 902, 903 in a temporally synchronous manner according to the preconditioned adjusting action, as described in detail above in relation to FIGS. 9, 2, and 7.

The drive system 900 or the associated method 1000 can be utilized in all applications where multiple positioning drives with decentralized electronics have to carry out synchronous adjustments, such as e.g. in laundry folding machines, table height adjustment systems, and automobile sliding roofs with connected covers.

All features explained and shown in connection with individual embodiments of the invention can be provided in different combinations in the inventive object in order to implement their advantageous effects simultaneously.

The scope of protection of the present invention is given by the claims and is not limited by the features explained in the description or shown in the figures.

### LIST OF REFERENCE CHARACTERS

100 Laundry folding device
101 Control panel
102 Intakes for laundry to be folded
103 Output or storage space for folded laundry
200 Drive system
201,
202,
203,
204,
205,
206,
207,
208 Actuator or motor
211,
212,
213,
214,
215,
216,
217,
218 Electronic motor controller (MCU), slave bus node or decentralized control modules
220 Central controller
230 Data bus and trigger line
240 Sensor line
250 Power supply
251 Power supply line
301,
302,
303,
304,
305 Illustrations of an arrangement consisting of a motor and motor control unit (MCU)
400 Arrangement consisting of a motor control unit and motor
500 Motor control unit
501 Motor connection
502 Signal connection
503 Power connection
600 Signal diagram of activation signals of a drive system
601 Polling inquiry: motor x
602 Start command: motor x
610 Messages
611 Sensor M01
613 Signal: motor on M02
614 Signal: motor on M03
615 Signal: motor on M04
700 Signal diagram of activation signals of a drive system
701 Polling inquiry: motor x
702 Start command: motor x
703 Command: generate trigger motor x
704 Pause to send trigger signal
710 Messages
711 Sensor M01
712 Trigger M01
713 Signal: motor on M02
714 Signal: motor on M03
715 Signal: motor on M04
800 Trigger circuit
802 First port
801 Second port
803,
804,
805,
808,
810,
812 Resistances
806 Second potential, ground
811 First potential
807 Transistor
809 Diode
813 Trigger line
900 Drive system
901,
902,
903 Actuator or motor
911,
912,
913 Electronic motor controller (MCU)
920 Central controller
921 Preconditioning message
922 Trigger signal
930 Data bus
940 Trigger line
1000 Method
1001 First step
1002 Second step

1-15. (canceled)

16. A laundry device, comprising:
a drive system, containing:
a plurality of actuators for executing synchronized adjusting actions;
a data bus;
a trigger line;
a plurality of decentralized control modules, being assigned to said actuators, and being connected to one another via said data bus; and
a central controller for controlling said actuators via said data bus and said decentralized control modules, said central controller being configured to send a preconditioning message with information relating to preconditioning an adjusting action of at least one portion of said actuators via said data bus to said decentralized control modules, said central controller or one of said decentralized control modules being configured to send a trigger signal to said decentralized control modules via said trigger line after a sending of the preconditioning message, wherein the trigger signal prompting said decentralized control modules to activate said actuators in a temporally synchronous manner according to a preconditioned adjusting action.

17. The laundry device according to claim 16, wherein said central controller is configured to transmit the preconditioning message asynchronously to said decentralized control modules via said data bus.

18. The laundry device according to claim 16, wherein said central controller is configured to transmit the preconditioning message to said decentralized control modules via said data bus according to a serial single-wire bus protocol with master/slave configuration.

19. The laundry device according to claim 16, wherein said central controller has a bus master, which is configured to activate said decentralized control modules in a polling method.

20. The laundry device according to claim 16, wherein said central controller is configured to activate said decentralized control modules with a latency time of more than 20 milliseconds.

21. The laundry device according to claim 16, wherein the preconditioning message extends over at least one data frame, wherein the at least one data frame has an identifier of a corresponding actuator of said at least one portion of said actuators that are affected by the preconditioning.

22. The laundry device according to claim 16, wherein said central controller is configured to interrupt data traffic on said data bus and to send the trigger signal via said data bus during an interruption.

23. The laundry device according to claim 16, wherein said central controller is configured to activate said actuators in a temporally synchronous manner within a data frame on said data bus that follows the trigger signal.

24. The laundry device according to claim 16, wherein the adjusting action occurs in response to a sensor signal, which indicates a status transition of a respective actuator of said actuators that does not belong to said at least one portion of said actuators to be adjusted.

25. The laundry device according to claim 16, wherein the trigger signal contains a coding, which states a specific configuration of the adjusting action.

26. The laundry device according to claim 25, wherein the trigger signal is coded on a basis of a pulse length of the trigger signal.

27. The laundry device according to claim 16, wherein:
said drive system has a trigger circuit configured to generate and/or to read the trigger signal; and
said central controller and/or said decentralized control modules are configured to activate said trigger circuit to generate and/or to read the trigger signal.

28. The laundry device according to claim 27, wherein said trigger circuit contains:
a trigger line for providing the trigger signal;
a transistor, which activates said trigger line to adopt a first or a second potential;
a first port, which activates said transistor to set said trigger line to the second potential; and
a second port, which indicates a status of said trigger line.

29. A drive system for a laundry device, the drive system comprising:
a data bus;
a trigger line;
a plurality of actuators for executing synchronized adjusting actions;
a plurality of decentralized control modules, being assigned to respective ones of said actuators, and being connected to one another via said data bus; and
a central controller for controlling said actuators via said data bus and said decentralized control modules, said central controller being configured to send a preconditioning message with information relating to preconditioning an adjusting action of at least one portion of said actuators via said data bus to said decentralized control modules, said central controller or one of said decentralized control modules configured to send a trigger signal to said decentralized control modules via said trigger line after a sending of the preconditioning message, wherein the trigger signal prompting said decentralized control modules to activate said actuators in a temporally synchronous manner according to a preconditioned adjusting action.

30. A method for operating a laundry device containing a drive system having a plurality of actuators for executing synchronized adjusting actions, a plurality of decentralized control modules being assigned to respective ones of the actuators, and which are connected to one another via a data bus, and a central controller for controlling the actuators via the data bus and the decentralized control modules, the method comprises the following steps of:
sending a preconditioning message with information relating to preconditioning an adjusting action of at least one portion of the actuators by the central controller via the data bus to the decentralized control modules; and
sending a trigger signal from the central controller or from one of the decentralized control modules to the decentralized control modules via a trigger line after the sending of the preconditioning message, wherein the trigger signal prompts the decentralized control modules to activate the actuators in a temporally synchronous manner according to the preconditioned adjusting action.
